(19) United States
(12) Patent Application Publication
(10) Pub. No.: US 2005/0089201 A1
(43) Pub. Date: Apr. 28, 2005

(54) Fingerprinting method for enrollment, authentication and updates

(76) Inventor: Irma Blancas, San Antonio, TX (US)

Correspondence Address: Pathway Enterprises, Inc.;Attn: Irma Blancas, P. O. Box 691287, San Antonio, TX, 78269-1287, US

(21) Appl. No.: 10/693,410

(22) Filed: Oct. 24, 2003

(51) Int. Cl. G06T 1/00

(52) U.S. Cl. 382/124; 340/5.83

(57) ABSTRACT

The invention relates a method of increasing the trust level associated with using fingerprint readers for the enrollment and authentication of an individual's fingerprints. This process requires the inspection of an individual's hand, fingers and fingertips by an agent prior to a fingerprint scan. On passing the inspection, the agent will then scan the individual's fingertips with a fingerprint scanner. Upon verification of an individual's identity using the individual's fingerprints then access to facilities, information and other things can be granted. Additionally, passwords or Personnel Identification Number (PIN) of the individual can be updated or changed.

### FEDERALLY SPONSORED RESEARCH

Not Applicable.

### SEQUENCE LISTING OR PROGRAM

Not Applicable.

### BACKGROUND

1. Field of Invention

The method of the invention relates to increasing the trust level associated with using fingerprint readers for the enrollment and authentication of an individual. The specific field includes information, security to include password or Personal Identification Number (PIN) updates, and biometrics (fingerprints).

2. Description of Prior Art

Identification of an individual using fingerprints is performed because no two individuals have been found to have the same fingerprint. Even identical twins do not have the same fingerprints. Fingerprints are formed based on the placement of the baby within the womb, which continuously moves around in the womb, as the fingers are developed making it unlikely that two individuals would have the same fingerprint.

Initially, fingerprints were taken manually by law enforcement organizations to identify individuals using their fingerprints. An individual would press their fingertips on an inkpad and then press their fingertips onto a piece of paper. As technology progressed, electronic fingerprint readers were developed to read an individual's fingerprint. The fingerprint reader's software scans an individual's fingertips, and requests information on the individual whose fingertips have been scanned. The fingerprint reader's software then enters the information (fingertip scan with the individual's information) into a file, list, database, or onto an integrated circuit card (smart card). This “enrollment” process creates the initial fingerprint template in which other fingerprint scans will be compared against.

For example, when an individual requires access to a facility or information (sometimes located in a computer system), the individual places their fingertip on the fingerprint reader or scanner. The individuals fingerprint is scanned and compared to the individuals fingerprint template in a database or in an integrated circuit card (smart card), or even an optical or magnetic card taken during the enrollment process. If the two fingerprints are identical then the individual has been successfully authenticated. This results in the ability of identifying an individual using their fingerprints for access to facilities and information.

Our comfort with fingerprints as a means of identifying an individual has further increased its usage. Today, fingerprint readers scan an individual's fingerprint to identify an individual for access to many things such as software applications, computer systems and computer networks. This has begun to replace User id's and password which is predominately the method of identifying an individual for access to computer systems. Using fingerprints for access reduces the overhead associated with having to reissue user id's and the resetting of passwords since most people forget one or both of them, multiple times.

Fingerprints as a method of identification have their weaknesses. Various methods of “faking” another individuals fingerprint or “using an individuals fingerprint” have been discovered. These include (1) forcing the registered user under duress or with a sleeping drug to use their fingerprint (2) using a severed fingertip from a registered finger (3) an artificial clone of the registered finger and other methods. Most patents, such as U.S. Pat. No. 6,484,260 or No. 4,933,976, address the technical aspects of the actual fingerprint scanning and its system but not the environment associated with scanning the fingerprint. This leaves a flaw in the use of fingerprint scanning to identify an individual.

The weaknesses in fingerprints as a means of identification are more pronounce in the E-commerce industry. This is an industry that continues to grow stronger than initial imagined. Using fingerprints as a means of authenticating individual's over the Internet for e-commerce purposes presents the problem of an individual being forced under duress or in an unconscious state to use their fingerprints to authorize actions such as a purchase of an item or the transfer of funds into someone else's account. A suggested solution to this problem is panic buttons for individuals or requiring an additional password (U.S. Pat. No. 6,256,402). Installation of a panic button would require the wiring and monitoring of the panic button alarm in every home. An additional password would result in increased overhead associated with issuing and resetting the password. This is the overhead cost fingerprint authentication was to reduce.

A second way of “fooling” a fingerprint reader is through the use of a severed fingertip from a registered finger. Studies, performed by Universities, using a cadaver's fingertip have been able to spoof fingerprint readers, which incorporated capacitive DC, capacitive AC, optical or opto-electronic technologies, 40-94% of the time. Suggested solutions include analysis of perspiration or heartbeat on the fingertip. These are known as liveness detection based on recognition of physiological information as signs of life. The perspiration method considers the grey levels along the ridges where differences in moisture correspond to differences in grey levels. This study is in its initial testing and it is unknown if perspiration characteristics is common over a large range of people or even if just adding a solution to the fingertip will fool the fingerprint scanner. Detection of a heartbeat to determine aliveness of a fingertip also has its problems. University studies have indicated that detection of pulsations can be faked by using a translucent fake finger why covers only the fingertip. U.S. Pat. No. 5,737,439 demonstrates a method in which a biometric scanner detects blood flow to determine aliveness. It describes a method of detecting fraud by detecting movement by the object in an attempt to deceptively simulate blood flow. However, it does not demonstrate a method of identifying whether the object is a translucent fake finger that would indicate blood flow.

A third method of “fooling” a fingerprint reader is through the use of an artificial clone of the registered fingerprint. Another University study describes two methods of creating a fingerprint clone. The first method required the use of molding plastic and gelatin to create a fake fingerprint from an authorized user's finger in less than an hour. This is called a “gummy finger”. Studies indicated this method fooled 11 commercially available fingerprint detectors between 70-95% of the time. A second method uses latent fingerprints left by a person on various surfaces. The fingerprint is lifted using a microscope, cleaned up with digital photography tools, and then printed onto a transparent sheet. The sheet is used to expose a photosensitive printed circuit board, which is then etched to create fingerprint impressions in the board. Finally, the gelatin is poured over the etched print and allowed to cool, creating the gummy finger. This method has more success in fooling the 11 different fingerprint readers from 80-100 percent of the time. The material used to create these gummy fingers is readily available at a low cost.

In summary, fingerprint readers can be fooled. Various methods have been developed which can authenticate an individual to access facilities or information through the use of “fake” fingerprints.

### OBJECTS AND ADVANTAGES

Accordingly, several objects and advantages of the present invention are:
(a) to provide a method that reduces the likelihood of enrolling or authenticating an individual, through the use of a fingerprint reader, under duress or without the individuals knowledge
(b) to provide a method that reduces the likelihood in which severed fingertips are used to enroll an individual
(c) to provide a method that reduces the likelihood in which severed fingertips of a registered user are used to authenticate an individual
(d) to provide a method that reduces the likelihood in which an artificial clone such as a “gummy finger” is used to enroll or authenticate an individual
(e) to provide a method in which fingerprints readers, can be used to change their password or personal identification number, by reducing the likelihood of an individual impersonating another individual through the use of armed duress, without the individuals knowledge, severed fingertips or a “gummy finger”
(f) to increase the trust associated with the authentication of fingerprints for the purpose of enrollment, and authentication.

Further objects and advantages of the invention or method will become apparent from a consideration of the drawings and ensuing description.

### SUMMARY

In accordance with the present invention of a method that provides a means of using a fingerprint reader to enroll and authenticate an individual with increased trust that it is the actual individual being enrolled or authenticated.

### DRAWINGS

Drawing Figures

FIG. 1 shows a method for enrolling, and authenticating an individual using a fingerprint reader or scanner

FIG. 2 shows a method of authenticating an individual for updating a password or Personal Identification Number (PIN)

### DETAILED DESCRIPTION

As discussed, using fingerprints to authenticate an individual has weaknesses. Various methods of “fooling” a fingerprint reader to enroll or authenticate an imposter are readily available and cheap. The method described below is the preferred process of eliminating weaknesses in using fingerprints to identify an individual by performing steps to ensure the fingerprint reader is not being “fooled”.

The preferred embodiments of the invention encompasses:

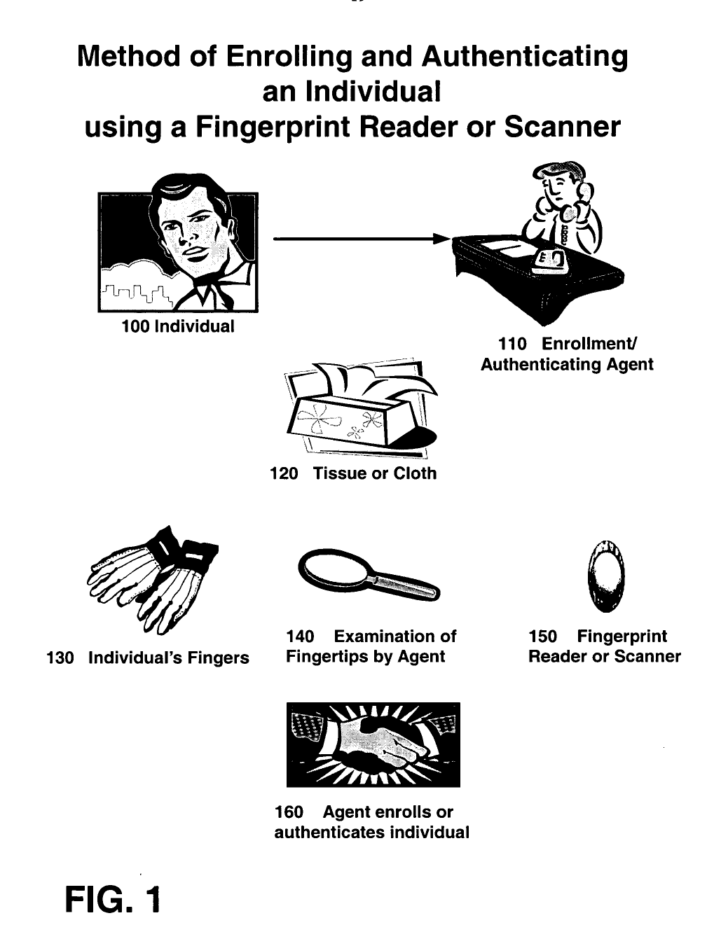

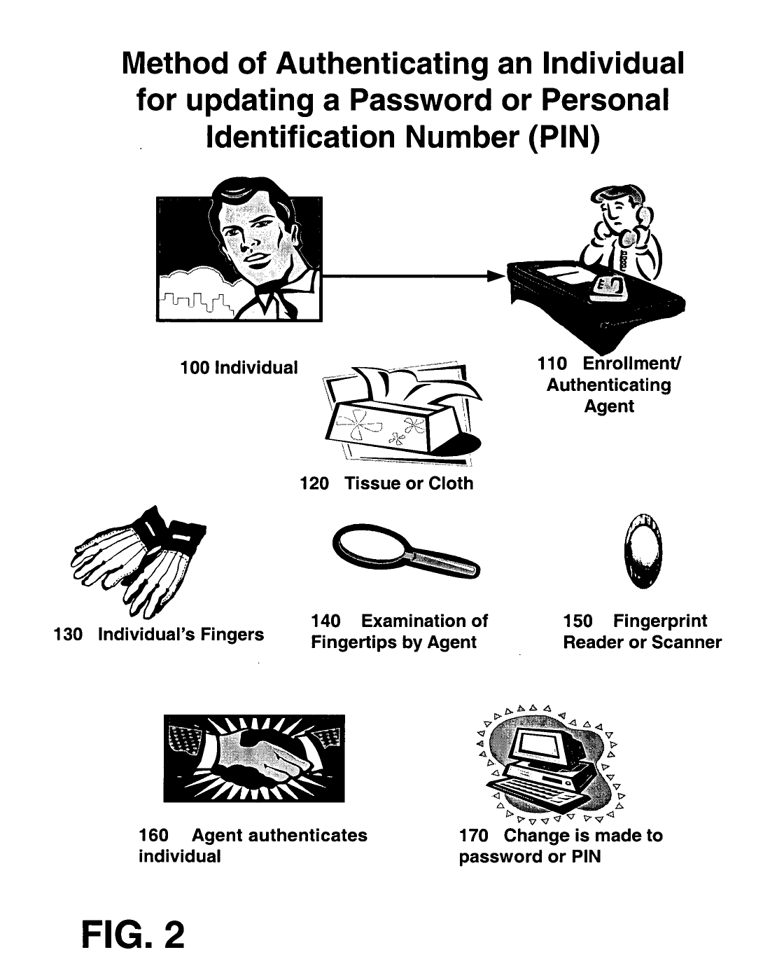

Description—FIGS. 1 and 2—Preferred Embodiment

1. Method of Enrolling and Authenticating an Individual Using a Fingerprint Reader or Scanner (FIG. 1)

To be enrolled or authenticated, an individual 100 will go to a central location where an agent 110 will inspect the individual's fingers or fingertips prior to using the fingerprint reader or scanner 130. The agent will ask the individual if they are under armed duress or in someway being cohered. If yes, then the agent will ring the alarm to alert the authorities. If the individual says no, the agent will ask the individual to rub, clean, and wipe a tissue or cloth 120 with their fingers and hands. The cloth can contain a solution to help dislodge or remove any “fake” fingertips. The agent will request to visually inspect 140 the individual's fingers or fingertips ensuring that no “gummy fingers” or an artificial clone fingertips are being used. This method will also prevent other methods of “fooling” a fingerprint scanner. Once the agent is satisfied that the fingertips are the actual individuals then the agent will ask the individual to place his or her fingertip on the fingerprint reader or scanner 150. Using the fingerprint reader or scanner software, the agent is able to enroll the individual's 160 identity by creating and saving a fingerprint template into a database, file, or listing with the individual's identity information. The agent can also authenticate the individual by comparing the scanned image with an existing fingerprint template taken for the individual during an enrollment process.

Alternate 1

After the individual has been authenticated, then the agent wipes clean of fingerprints the fingerprint reader with a soft cloth or tissue.

2. Method of Authenticating an Individual for updating a Password or Personal Identification Number (PIN) (FIG. 2)

To be authenticated, an individual 100 will go to a central location where an agent 110 will inspect the individual's fingers or fingertips prior to using the fingerprint reader or scanner 130. The agent will ask the individual if they are under armed duress or in someway being cohered. If yes, then the agent will ring the alarm to alert the authorities. If the individual says no, the agent will ask the individual to rub, clean, and wipe a tissue or cloth 120 with their fingers and hands. The cloth can contain a solution such as water to help dislodge or remove any “fake” fingertips. The agent will request to visually inspect 140 the individual's fingers or fingertips ensuring that no “gummy fingers” or an artificial clone fingertips are being used. This method will also prevent other methods of “fooling” a fingerprint scanner. Once the agent is satisfied that the fingertips are the actual individuals and the individual is not being coerced in someway the agent will ask the individual to place his or her fingertip on the fingerprint reader or scanner 150. Using the fingerprint reader or scanner software, the agent is able to authenticate the individual's 160 fingerprint by comparing the fingerprint scan to a previous fingerprint scan (initial enrollment of the fingerprint scan) located in a database, file, or listing with the individual's identity information. If the comparison of the two fingerprints matches then the individual will be 170 allowed to update or change their password or Personal Identification Number (PIN).

Alternate 1

After the individual has been authenticated, then the agent wipes clean of fingerprints the fingerprint reader with a soft cloth or tissue.

Advantages

From the description above, a number of advantages become evident:
(a) An agent can ensure that an individual is not acting under duress or is in an unconscious state when he or she is enrolled or authenticated by scanning or reading their fingerprints or fingertips through the use of fingerprint reader or scanner
(b) An individual cannot use a severed finger or fingertip to authenticate himself or herself as someone else through the use of fingerprint reader or scanner
(c) An agent can ensure that the individual whose fingerprints or fingertips are being scanned for enrolled or authenticate purposes is actually alive
(d) Ensuring that only authorized personnel have access to a facility or information by inspecting the individual's fingers or fingertips prior to a fingerprint scan
(e) Inspecting the individual's fingers or fingertips will ensure no “gummy fingers” are used in the enrollment or authentication process prior to a fingerprint scan
(f) An individual rubbing, cleaning, and wiping a tissue or cloth with their fingers or fingertips will help to dislodge or remove “fake” fingertips
(g) Cleaning and wiping of the individual fingers will clean the fingertips of dirt ensuring a better scan of the fingertip image
(h) Increasing the trust level associated with using fingerprint reader or scanner to authenticate or identify an individual
   Operation—FIG. 1

An individual 100 goes to a location where an agent request the individual to rub, clean, and wipe their hands 130 in particular their fingertips using a soft cloth or tissue 120. The item used to rub, clean, and wipe an individuals hands and fingertips will be such that it remove or dislodge the dummy fingers, mold, or plastic impressions of a fingertip. An agent will then physically and visually examine the individual's hands and fingertips 140. This will be done manually. Next, the agent will inspect the individual's hands and fingertips. If no “fake” fingertips are found, the agent will then scan the individual's fingertips using a fingerprint reader or scanner 150 for the purpose of enrolling or authenticating an individual 160. There are many fingerprint readers or scanners on the market. One of the being the Precise 100 A manufactured by Precise Biometrics which contains software which can enroll, and can authenticate an individual's fingerprints by comparing the enrolled fingerprint with the scanned fingerprint or a fingerprint in an integrated circuit card (smart card).

### CONCLUSION, RAMIFICATIONS, AND SCOPE

Our comfort level and the uniqueness of everyone's fingerprint, makes fingerprints one of the ideal methods for identification of individuals for access to facilities, information and other things. However, methods to “fool” an electronic fingerprint reader or scanner have been discovered. This has hurt the biometric “fingerprint” industry. However, this invention describes a method that can be used to increase the trust level associated with enrollment, and authentication of an individual's fingerprint or fingertip using a fingerprint reader or scanner.

1. A method of enrolling an individual using a fingerprint reader or scanner comprising:
a. providing an agent to inspect said individual prior to a fingerprint scan comprising of:
1. inspecting said individual's fingertips
b. rejecting said individual for a fingerprint scan if said agent determines fingerprint scan will be invalid
whereby said method increases the trustworthiness of a fingerprint or fingertip scan to identify an individual in the enrollment process.

2. A method as recited in claim 1, further including:
a. providing an agent to inspect said individual prior to a fingerprint scan comprising of:
1. inspecting said individual's hands and
2. inspecting said individual's fingers and
3. inspecting said individual's fingertips
whereby said method increases the trustworthiness of a fingerprint or fingertip scan to identify an individual in the enrollment process.

3. A method as recited in claim 1, further including:
a. providing an agent to inspect said individual prior to a fingerprint scan comprising of:
1. inspecting said individual's hands and
2. inspecting said individual's fingers and
3. inspecting said individual's fingertips and
4. asking said individual whether they are in someway being coerced
whereby said method increases the trustworthiness of a fingerprint or fingertip scan to identify an individual, without coercion, in the enrollment process and to prevent unauthorized actions based upon said individual's fingerprint enrollment.

4. A method as recited in claim 1, further including:
a. providing an item for said individual to use with means of dislodging or removing external objects on an individual's fingertips prior to a fingerprint scan
whereby said method increases the trustworthiness of a fingerprint or fingertip scan to identify an individual in the enrollment process.

5. A method as recited in claim 1, further including:
a. providing an item for said individual to use with means of cleaning their fingers or fingertips prior to a fingerprint scan
whereby said method increases the trustworthiness of a fingerprint or fingertip scan to identify an individual in the enrollment process and for a better fingerprint image.

6. A method of authenticating an individual using a fingerprint reader or scanner comprising:
a. providing an agent to inspect said individual prior to a fingerprint scan comprising of:
1. inspecting said individual's fingertips
b. rejecting said individual for a fingerprint scan if the said agent determines fingerprint scan will be invalid
whereby said method increases the trustworthiness of a fingerprint or fingertip scan to identify an individual for authorization of an action

7. A method as recited in claim 6, further including:
a. providing an agent to inspect said individual prior to a fingerprint scan comprising of:
1. inspecting said individual's hands and
2. inspecting said individual's fingers and
3. inspecting said individual's fingertips
whereby said method increases the trustworthiness of a fingerprint or fingertip scan to identify an individual for authorization of an action.

8. A method as recited in claim 6, further including:
a. providing an agent to inspect said individual prior to a fingerprint scan comprising of:
1. inspecting said individual's fingertips and
2. asking said individual whether they are in someway being coerced
whereby said method increases the trustworthiness of a fingerprint or fingertip scan to identify an individual, who is not being coerced, for authorization of an action.

9. A method as recited in claim 6, further including:
1. providing an item for said individual to use with means of cleaning their fingers or fingertips prior to a fingerprint scan
whereby said method increases the trustworthiness of a fingerprint or fingertip scan to identify an individual for authorization of an action.

10. A method as recited in claim 6, further including:
a. providing an item for said individual to use with means of cleaning their fingers or fingertips prior to a fingerprint scan
whereby said method increases the trustworthiness of a fingerprint or fingertip scan to identify an individual for authorization of an action and for a better fingerprint image.

11. A method of authenticating an individual using a fingerprint reader or scanner comprising:
a. providing an agent to inspect said individual prior to a fingerprint scan comprising of:
1. inspecting said individual's fingertips
b. providing an item for said individual to use with means of cleaning their fingers or fingertips prior to a fingerprint scan and
c. rejecting said individual for a fingerprint scan if said agent determines fingerprint scan will be invalid and
d. requesting said individual to place his or her fingertips on the fingerprint reader or scanner if said agent determines fingerprint scan will be valid and
e. a software application with means of indicating whether said individual's fingerprint scan matches an existing fingerprint template
whereby said method increases the trustworthiness of a fingerprint or fingertip scan to identify an individual for authorization of an action.

12. A method as recited in claim 11, further including:
a. approving access to a facility if said individual's fingerprint scan matches an authorized fingerprint template
whereby said method increases the trustworthiness of a fingerprint or fingertip scan to identify an individual for authorization of an action.

13. A method as recited in claim 11, further including:
a. approving access to data, wherever it resides, if said individual's the fingerprint scan matches an authorized template
whereby said method increases the trustworthiness of a fingerprint or fingertip scan to identify an individual for authorization of an action.

14. A method as recited in claim 11, further including:
a. approving access to a software application or operating system if said individual's fingerprint scan matches an authorized template
whereby said method increases the trustworthiness of a fingerprint or fingertip scan to identify an individual for authorization of an action.

15. A method as recited in claim 11, further including:
a. approving access to an image if said individual's fingerprint scan matches an authorized template
whereby said method increases the trustworthiness of a fingerprint or fingertip scan to identify an individual for authorization of an action.

16. A method as recited in claim 11, further including:
a. approving access to update data if said individual's fingerprint scan matches an authorized template
whereby said method increases the trustworthiness of a fingerprint or fingertip scan to identify an individual for authorization of an action.

17. A method as recited in claim 11, further including:
a. allowing said individual to update a password if said individual's fingerprint scan matches an authorized template
whereby said method increases the trustworthiness of a fingerprint or fingertip scan to identify an individual for authorization of an action.

18. A method as recited in claim 11, further including:
a. allowing said individual to update a userid if said individual's fingerprint scan matches an authorized template
whereby said method increases the trustworthiness of a fingerprint or fingertip scan to identify an individual for authorization of an action.

19. A method as recited in claim 11, further including:
a. allowing said individual to update a Personal Identification Number (PIN) if said individual's fingerprint scan matches an authorized template
whereby said method increases the trustworthiness of a fingerprint or fingertip scan to identify an individual for authorization of an action.
